(19) United States
(12) Patent Application Publication
(10) Pub. No.: US 2014/0331843 A1
(43) Pub. Date: Nov. 13, 2014

(54) SYSTEM OF INDEXABLE CUTTING PORTIONS FOR A SHEAR

(71) Applicant: Charlie Hall, Bartow, GA (US)

(72) Inventor: Charlie Hall, Bartow, GA (US)

(21) Appl. No.: 14/445,935

(22) Filed: Jul. 29, 2014

Related U.S. Application Data
(63) Continuation-in-part of application No. 14/207,978, filed on Mar. 13, 2014.
(60) Provisional application No. 61/781,418, filed on Mar. 14, 2013.

(51) Int. Cl. E02F 3/96; B23D 35/00; B23D 17/00

(52) U.S. Cl. CPC E02F 3/965; B23D 17/00; B23D 35/001
USPC 83/694

(57) ABSTRACT

The present disclosure describes various embodiments, as well as features and aspects thereof, of a system, for a shear, of fully indexable cutting portions comprises at least one blade and a plurality of substantially identical indexable cutting portions. The at least one blade is configured to mechanically receive a plurality of indexable cutting portions. The plurality of substantially identical indexable cutting portions are arranged on the at least one blade to form a composite angled cutting edge. The composite angled cutting edge comprises at least one angle. Each indexable cutting portion comprises a coupling portion and eight edges. The coupling portion of each indexable cutting portion is configured to mechanically engage the indexable cutting portion to the at least one blade.

### CROSS-REFERENCE TO RELATED APPLICATIONS

This U.S. non-provisional utility patent application is a continuation-in-part of, and claims priority under 35 U.S.C. §120 to, the U.S. non-provisional utility patent application entitled “Blade Device and System for Mobile Shear,” filed on Mar. 13, 2014 and assigned application Ser. No. 14/207,978, which claims priority under 35 U.S.C. §119(e) to, and incorporates by reference the entire contents of, U.S. provisional patent application entitled “Blade Device and System for a Mobile Shear,” filed on Mar. 14, 2013 and assigned application Ser. No. 61/781,418. The entire contents of each application are hereby incorporated by reference.

### BACKGROUND

The present disclosure relates to a system of removable and replaceable blades for a shear and, more particularly, to an improved system for a shear of indexable cutting portions.

Generally, simple shears are cutting instruments that comprise a pair of opposed blades. A simple shear usually cuts when the major plane of each blade, positioned substantially parallel to one another and with a relatively minimal amount of separation, slide over one another in a substantially overlapping, “scissor-like” fashion. Any material that is caught in-between the sliding major planes is sliced and separated by the increasingly overlapping edge of each blade (a “cutting edge”), so long as the position of each blade relative to the other is substantial maintained throughout the cutting action.

The cut is generally more precise and efficient, in terms of the amount of force needed to overlap the blades, if the cutting edge is sharpened such that the force is concentrated onto a relatively minimal area of the material to be cut. Even more precision and efficiency may be obtained, in some applications, if the sharpened cutting edge is serrated, i.e., a cutting edge with a plurality of points. A serrated edge may further concentrate a cutting force onto a discrete number points on the material to be cut.

Based on these fundamentals, more complex shears are possible for accomplishing more complex cutting tasks. For example, heavy duty and powerful mechanical shears have been designed for the efficient cutting of metals and other relatively hard materials (FIG. 1 depicts one non-limiting embodiment of a generic mechanical shear 101). These mechanical shears known in the art are typically comprised of powerful jaws having a plurality of substantially parallel major planes that function as blades. When the jaws close and the blades increasingly overlap, the cutting edges of the jaw deform, compress, slice and separate any material caught in between.

Regardless of the complexity of the shear, it is understood in the art that, generally, the blade must have certain material properties that are superior to those of the material it is intended to cut. If it does not, then the cutting edge will either deform or erode from its mechanical interaction with the material to be cut. However, even if a shear does have the necessary material properties, deformation and erosion and wear are ultimately inevitable. To combat wear and tear, a cutting edge may be maintained by honing, sharpening, welding up before honing or sharpening, and/or altogether replacing in whole or part.

Because more complex shears, like the generic mechanical shear described above, tend to require larger forces to cut relatively harder and more rigid materials, it is understood in the art that, generally, the cutting edges of these complex shears deform and erode more readily and quickly. Typically, these shears deform and erode because the difference between the material properties of the cutting edges of the jaw and the material to be cut are less significant, and because the magnitude of the mechanical forces involved in closing the jaws on the material to be cut are relatively large. While the above-mentioned maintenance techniques can be used to repair the cutting edges of the jaw, the shears are typically left substantially inoperable until the maintenance can be performed.

Consequently, because of these deficiencies, there is a need in the art for an improved system of indexable cutting portions for a mobile shear.

### SUMMARY

The present disclosure describes various embodiments, as well as features and aspects thereof, of a system, for a shear, of fully indexable cutting portions. More specifically, one non-limiting embodiment of a system, for a shear, of fully indexable cutting portions comprises at least one blade and a plurality of substantially identical indexable cutting portions. The at least one blade may be configured to mechanically receive a plurality of indexable cutting portions that are arranged on the at least one blade to form a composite angled cutting edge defining at least one angle. Each indexable cutting portion may comprise a coupling portion and eight edges, the coupling portion being configured to mechanically engage the indexable cutting portion to the at least one blade.

In the exemplary embodiment, the indexable cutting system for a shear may be such that each indexable cutting portion is interchangeable with each other indexable cutting portion. Furthermore, in the exemplary embodiment, a first edge of each indexable cutting portion may function as a cutting edge that is part of the composite angled cutting edge. Moreover, in the exemplary embodiment, at least one edge of each indexable cutting portion, other than the first edge that is part of the composite angled cutting edge, may be substantially parallel with at least one edge of an adjacent indexable cutting portion when mechanically attached to a blade of the mobile shear. Even further, in the exemplary embodiment, each indexable cutting portion may be configured to be rotated and/or inverted such that any one of its eight edges is a cutting edge that is part of the composite angled cutting edge.

Various embodiments, configurations, features and aspects of the system, for a shear, of fully indexable cutting portions are described in more detail in the detailed description with reference to the attached drawings.

### BRIEF DESCRIPTION OF THE SEVERAL VIEWS OF THE DRAWING

FIG. 1 is a bottom and side perspective view of a generic mechanical shear known in the art (PRIOR ART).

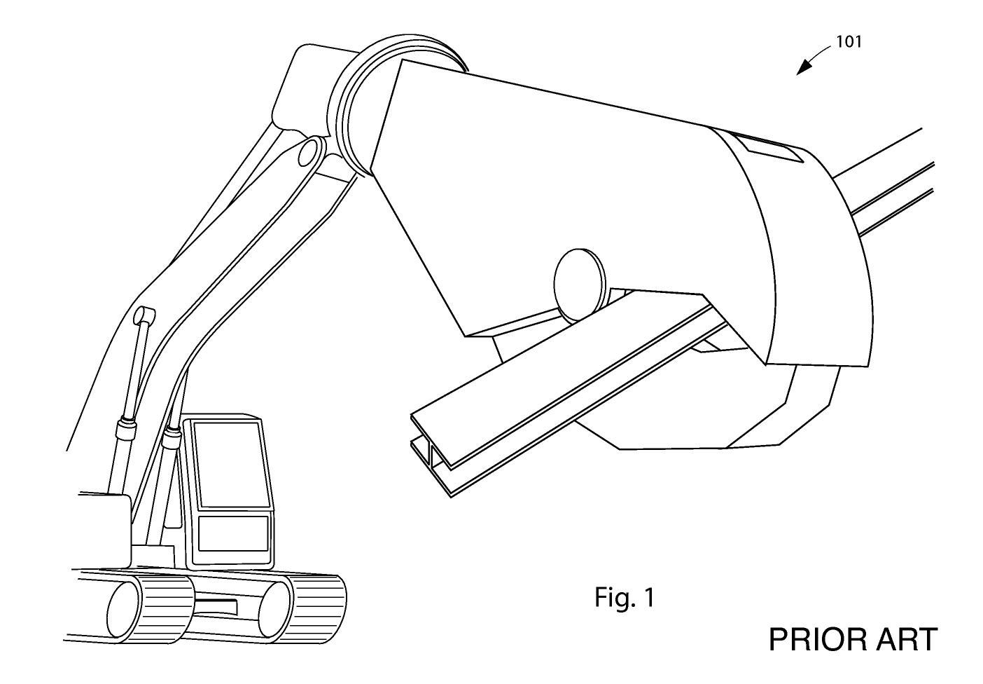

FIG. 2. is a bottom and side perspective view of a mechanical shear comprising one non-limiting embodiment of a system of fully indexable cutting portions.

FIG. 3. is a bottom and side perspective view of the opposite side of the mechanical shear comprising the one non-limiting embodiment of a system of fully indexable cutting portions of FIG. 2.

FIG. 4. is a top and side exploded view of the non-limiting embodiment of a system of fully indexable cutting portions shown in FIGS. 2-3.

### DETAILED DESCRIPTION OF VARIOUS EMBODIMENTS

The following written description describes various exemplary embodiments of a system, for a shear, of fully indexable cutting portions. This written description refers to the appended drawings to supplement the written explanation. As such, the written words should not be construed as limitations. Numerous specific details are explained in the written description and depicted in the drawings to provide an enabling understanding of the various embodiments to one of ordinary skill in the art. Some details, however, need not be expressly explained because they would be readily apparent and understood by one of ordinary skill in the art. For example, certain described embodiments and explanations of some specific details are omitted so as to not unnecessarily obscure the written description. Additionally, one of ordinary skill in the art would understand that the various embodiments may be practiced without some or all of these specific details.

Although throughout the detailed description the various embodiments are directed towards a system, for a shear, of fully indexable cutting portions, it should be understood that the focus of such description is only to ensure clarity in the configuration and operation of the various embodiments. The description should not be used to limit the usefulness of the various embodiments in other manners or for other uses.

In order to maximize the operable time of a shear between maintenance of the cutting edges, it is beneficial for the jaws to comprise removable and replaceable cutting portions such that the shear can remain useful while the deformed and/or eroded cutting portions are removed and replaced. Moreover, there is a benefit to using single removable and replaceable cutting portions that have discrete cutting edges on different sides and/or planes of the cutting portion. These cutting portions can be rotated and/or inverted and replaced on the shear to expose a virgin cutting edge (i.e., partially indexable cutting portion) before maintenance of the indexable cutting portion is needed.

However, partially indexable cutting portions are not as beneficial as fully indexable cutting portions because partially indexable cutting portions may not maximize the utility of each individual indexable cutting portion prior to maintenance. Moreover, systems that comprise partially indexable cutting portions may be more complex than systems that use fully indexable cutting portions and, thus, may require differently shaped and/or sized indexable cutting portions at different locations along the system. Moreover, systems that comprise partially indexable cutting portions may rely on an attachment mechanism between the indexable cutting portions and the shear for the system to effectively cut. This may not be the case with a system of fully indexable cutting portions. Moreover, systems that comprise partially indexable cutting portions may rely on the differently shaped and/or sized indexable cutting portions for the system to effectively cut. This may not be the case with a system of fully indexable cutting portions. Morever, systems that comprise partially indexable cutting portions may rely on other structural features of the shear to maintain the necessary rigidity, alignment and orientation of the indexable cutting portions for the system to effectively cut. This may not be the case with a system of fully indexable cutting portions. Finally, users of systems that comprise partially indexable cutting portions may have the added concern of maintaining the attachment mechanisms for the differently shaped and/or sized indexable cutting portions and/or maintaining the other structural features of the shear (these maintenance routines can be substantially disparate and limiting in nature). This may not be the case with a system of fully indexable cutting portions.

As such, the various embodiments shown and described herein are related to a system, for a shear, of fully indexable cutting portions. The various embodiments of the system may be ideally suited for, without limitation, solving one or more of the stated deficiencies of systems the comprise partially indexable cutting portions. Furthermore, the various embodiments of the system may be particularly suited for, without limitation, forming composite cutting edges comprised of fully indexable cutting portions that, in and of themselves, remain substantially aligned, oriented and rigid, when performing their cutting function. Furthermore, various embodiments of the proposed solution may be ideally suited for, without limitation, forming angled composite cutting edges that facilitate the drawing of material to be cut towards increasingly overlapping cutting edges of the blades as the shear closes.

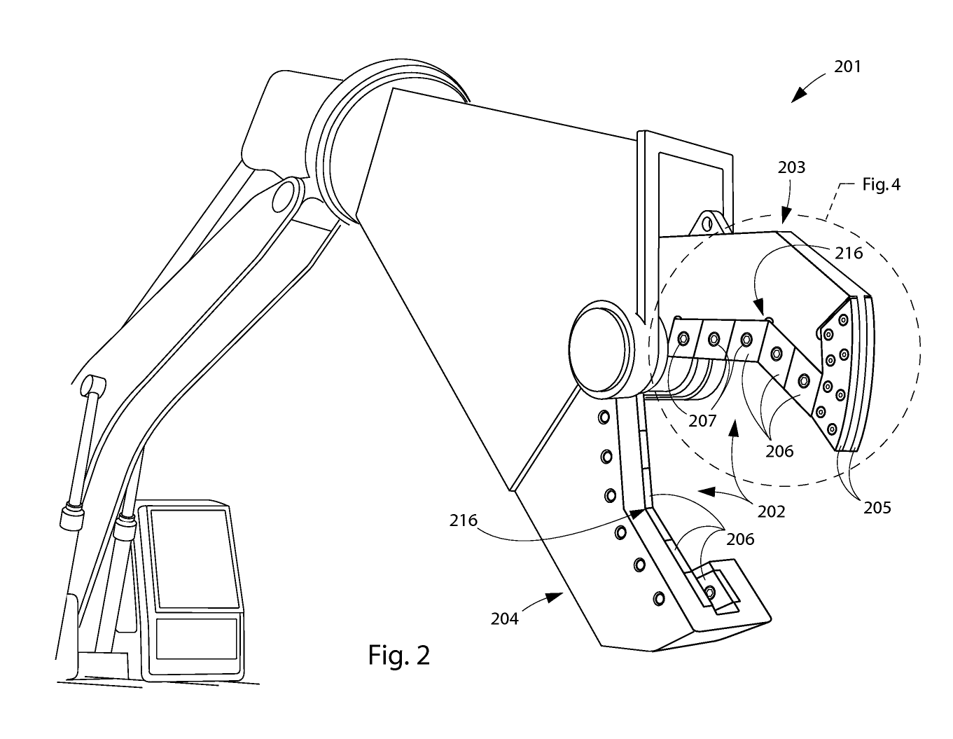

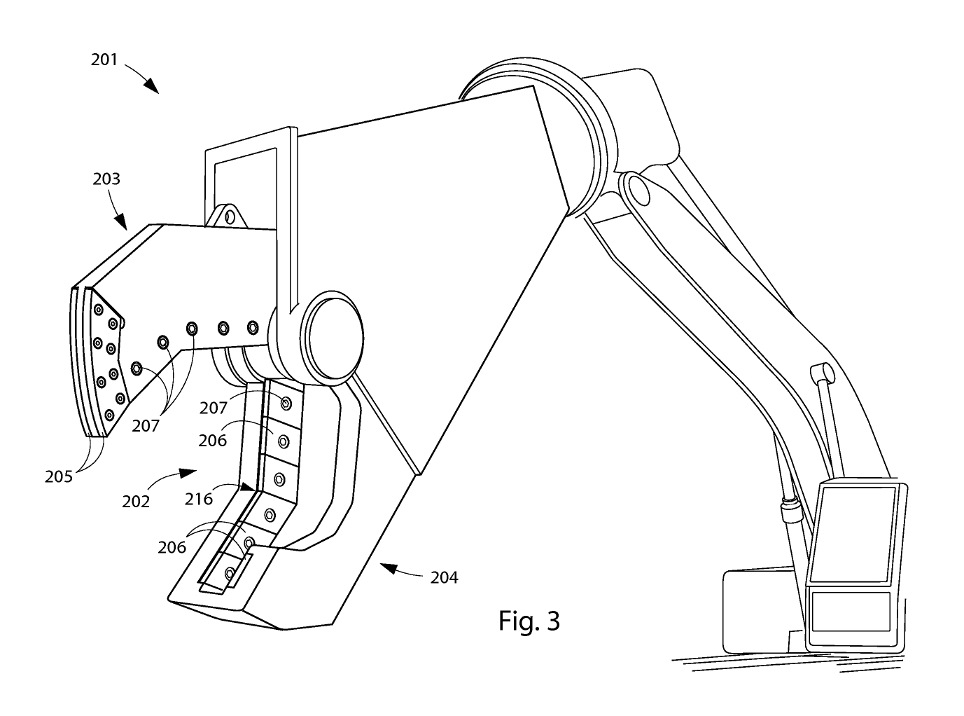

Referring now to the drawings, which are described and included herein for the purpose of illustrating various exemplary embodiments of the proposed solution only and not for purposes of limiting the same, FIGS. 2-3 depict one non-limiting embodiment of a mechanical shear 201 comprising one non-limiting embodiment of a system of fully indexable cutting portions 202, one non-limiting embodiment of a top jaw or blade 203 for receiving some of the indexable cutting portions 202, one non-limiting embodiment a bottom jaw or blade 204 for receiving some of the indexable cutting portions 202, and one non-limiting embodiment of a top jaw tip blade 205.

The exemplary system of fully indexable cutting portions 202 engages with top jaw 203 and bottom jaw 204 and top jaw tip plate 205 such that system 202 functions as at least a portion of the blades of the mechanical shear 201. One having ordinary skill in the art recognizes that the overall engineering, configuration and/or composition of shear 201 (i.e., how many top jaw 203 and bottom jaw 204 pairs are present, whether top jaw 203 and/or bottom jaws 204 are fixed, movable or hybrid, and how top jaw 203 and bottom jaw 204 are connected and comprised) does not limit the present disclosure. The same is true with respect to the spatial orientation, location and relative proportions of system 202 as it forms shear 201 (i.e., whether system 202 engages with the top jaw 203 and/or bottom jaw 204 or, at least a portion of top jaw 203 and/or bottom jaw 204, and whether the proportion of system 202 surface area to total jaw surface area is relatively small or large).

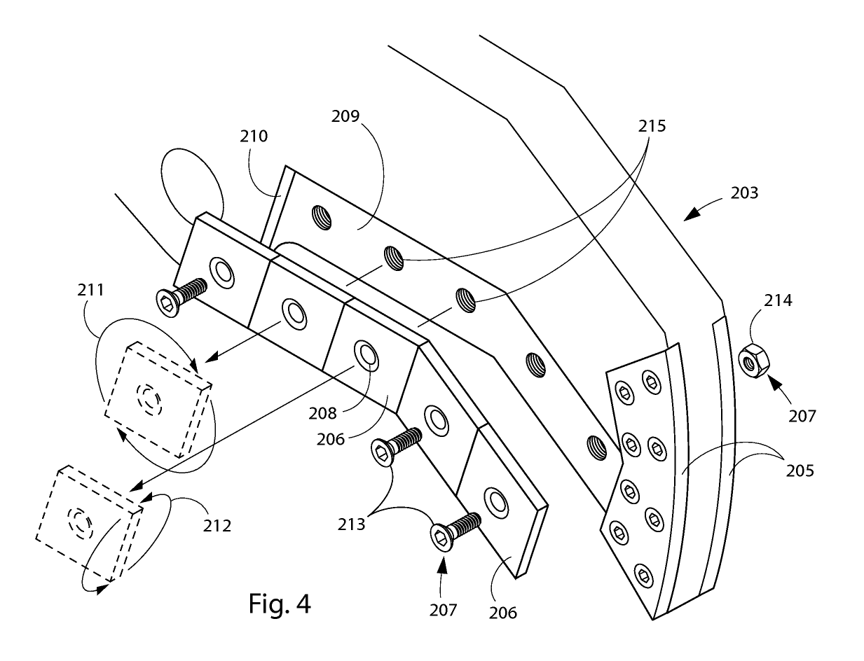

Returning to FIGS. 2-3, the exemplary system of fully indexable cutting portions 202 comprises multiple fully indexable cutting portions 206 that each include a coupling portion 207 for detachably coupling its associated cutting portion 206 to top jaw 203 and/or bottom jaw 204. In FIG. 4., which is an enlarged top and side exploded view of a portion of the exemplary system 202 illustrated in FIGS. 2-3, it can be seen that each fully indexable cutting portion 206 is engaged with top jaw 203 via a coupling portion 207. The coupling portion 207 is depicted in the form of a bolt 213 and nut 214, which runs through central aperture 208 of its associated cutting portion 206, and an aperture 215 of top jaw 203. It is envisioned that, in at least one other non-limiting embodiment, coupling portion 207 may be an adhesive, a fastener, or any other means for detachably coupling known to one of ordinary skill in the art. It is further envisioned that coupling portion 207 may be composed of a steel amalgam, an aluminum amalgam, a ceramic, a polymer or any other material known to one of ordinary skill in the art. Additionally, coupling portion 207 is not necessarily limited to a ratio of one coupling portion 207 to one cutting portion 206. Instead, it is envisioned that coupling portion 207 may be one single piece, multiple discrete pieces and/or pieces that compliment/facilitate the function of a detachable coupling mechanism.

Returning to FIGS. 2-3, each individual fully indexable cutting portion 206 is depicted as detachably coupling side-by-side to either top jaw 203 or bottom jaw 204. Through its respective coupling portion 207, each cutting portion 206, along with all other cuttings portions 206 (a “plurality of individual fully indexable cutting portions 206”), form one non-limiting embodiment of a composite angled cutting edge 216 on top jaw 203 and, separately, on bottom jaw 204. As would be understood to one of ordinary skill in the art, the at least one angle 216 of the composite angled cutting edge facilitates the drawing of material to be cut towards the increasingly overlapping top jaw 203 and bottom jaw 204, which function as blades, as mechanical shear 201 closes.

It is envisioned that, in at least one non-limiting embodiment, the composite angled cutting edge may form an angle 216 between about 91.0 degrees and about 179.0 degrees, preferably between about 105.0 degrees and about 165.0 degrees and ideally between about 120.0 degrees and about 150.0 degrees. It is further envisioned that, in at least one non-limiting embodiment, each individual fully indexable cutting portion 206 may detachably couple physically side-by-side (as depicted in FIGS. 2-4), and/or it may detachably couple side-by-side with an intermediate buffer portion, e.g., a spacer, that engages with at least a portion of an adjacent cutting portion 206 and/or at least a portion of top jaw 203 and bottom jaw 204.

Advantageously, in some embodiments of the solution, the composite angled cutting edge 216 of top jaw 203 and/or bottom jaw 204 remains substantially aligned, oriented and rigid when cutting because each individual fully indexable cutting portion 206 substantially supports the alignment and orientation of the adjacent cutting portion 206. While coupling portion 207 and/or certain structural features of mechanical shear 201 may contribute in effect, it is the support provided by each cutting portion 206 to the adjacent cutting portion 206 that substantially maintains this alignment and orientation of each cutting portion 206 within the system 202. For example, in one non-limiting embodiment, shear 201 may additionally comprise a recess, pocket, groove, and/or recess wall, or any other similar structural feature known to one having ordinary skill in the art. These structural features of shear 201, along with coupling portion 207, may contribute in effect to maintaining the alignment and orientation of each cutting portion 206. However, it is the support provided by each cutting portion 206 to its adjacent cutting portion 206 that substantially maintains this alignment and orientation in this non-limiting embodiment.

For example, as can be seen in FIG. 2 and FIG. 4. together, the composite angled cutting edge 216 of top jaw 203 is depicted as engaging with top jaw tip plate 205 via one non-limiting embodiment of a recess 209 and one non-limiting embodiment of a recess wall 210. While these structural features of mechanical shear 201 contribute to supporting the alignment and orientation of individual fully indexable cutting portions 206, it is envisioned that a system 202 of fully indexable cutting portions 206 is operative to maintain the alignment, orientation and rigidity of its composite angled cutting edge even if top jaw tip plate 205, recess 209 and/or recess wall 210 were missing. This is true because cutting portion 206 substantially prevents the rotational movement 211 of the adjacent cutting portion 206 in and of itself, as described more fully below.

Returning to FIGS. 2-4, an individual fully indexable cutting portion 206 is depicted as one non-limiting embodiment of a parallelepiped comprising at least one non-limiting embodiment of a pair of equal parallel sides shaped substantially as rhombi. Each cutting portion 206 has substantially the same height, depth, width and volume and is detachably coupled to top jaw 203 or bottom jaw 204 such that one of the at least one pair of cutting portions 206 is distal to top jaw 203 and bottom jaw 204, and the other of the at least one pair is proximate to top jaw 203 and bottom jaw 204.

It is envisioned that the three-dimensional shape of an individual fully indexable cutting portion 206 is not limited to a parallelepiped so long as the shape is consistent with the defining characteristics of system 202 of fully indexable cutting portions 206, as described above and below (i.e., the plurality of cutting portions 206 being operative to substantially support the alignment and orientation of their adjacent cutting portions 206 such that the composite angled cutting edge remains substantially aligned, oriented and rigid when cutting). Additionally, it is envisioned that the shape of the at least one pair of equal parallel sides of cutting portion 206 is not limited to a rhombi so long as the shape is consistent with this defining characteristics of system 202, as described above and below. Furthermore, it is envisioned that when cutting portion 206 is detachably coupled to top jaw 203 or bottom jaw 204, the pair of equal parallel sides of cutting portion 206 aligns substantially parallel along the contours of top jaw 203 or bottom jaw 204. Because of this, as mechanical shear 201 closes, top jaw 203 and bottom jaw 204 are operative to function as blades via their respective composite cutting edges 216 formed from the plurality of individual fully indexable cutting portions 206.

Consequently, one of ordinary skill in the art understands that all edges of the distal side of the at least one pair of equal parallel sides of individual fully indexable cutting portion 206 may function as at least a portion of the angled composite cutting edge 216 of top jaw 203 and bottom jaw 204. Of course, this depends on the orientation of cutting portion 206 when it is detachably coupled to top jaw 203 or bottom jaw 204. For example, as depicted in FIG. 4, element 211 illustrates how the orientation of cutting portion 206 may be rotated (i.e., an end-to-end plate rotation) to alternate the edge of the distal side that functions substantially as at least a portion of the angled composite cutting edge of top jaw 203 or bottom jaw 204.

Furthermore, it is envisioned that each individual fully indexable cutting portion 206 may be inverted (i.e., a face-to-face plate rotation) such that all edges of the previously proximate side of the at least one pair of equal parallel sides of cutting portion 206 can also function as at least a portion of the angled composite cutting edge 216 of top jaw 203 or bottom jaw 204. Of course, this depends on the orientation of cutting portion 206 when it is detachably coupled to top jaw 203 or bottom jaw 204. For example, as depicted in FIG. 4, element 212 illustrates how individual cutting portion 206 may be inverted to alternate the proximate and distal sides relative to top jaw 203 or bottom jaw 204. Like the previously distal side, the orientation of cutting portion 206 may be rotated, as depicted at element 211, to alternate the edge that functions substantially as at least a portion of the angled composite cutting edge 216 of top jaw 203 or bottom jaw 204.

Furthermore, because individual fully indexable cutting portions 206 all have substantially the same height, depth, width and volume, it is envisioned that any one cutting portion 206 may replace any other cutting portion 206 in system of fully indexable cutting portions 202. One of ordinary skill in the art recognizes that this substantial similarity and symmetry amongst the plurality of individual fully indexable cutting portions 206 also operates to create the at least one angle in the angled composite cutting edge 216 of top jaw 203 or bottom jaw 204. For example, in FIG. 2 the composite angled cutting edges 216 of top jaw 203 and bottom jaw 204 comprise at least one non-limiting embodiment of two adjacent cutting portions 206 wherein one is substantially aligned and oriented as a mirror image of the other to create the at least one angle in the composite cutting edge 216 of top jaw 203 and bottom jaw 204. One of ordinary skill in the art understands that the at least two adjacent cutting portions 206 are not limited to being substantially aligned and oriented as a mirror image of the other so long as their alignment and orientation with respect to one another operates to create the at least one angle in the angled composite cutting edge 216, as described above.

Moreover, it is envisioned that individual fully indexable cutting portions 206 may have varied shapes, sizes and volumes depending on the particular cutting need and/or the physical/chemical/structural properties of the mechanical shear 201. It is envisioned that cutting portion 206 may have various textures and/or contours throughout its entire surface area, or at least at one portion of the surface area. It is envisioned that cutting portion 206 may have various material compositions, densities etc. throughout its entire volume, or at least at one portion of the volume, so long as cutting portion 206 remains consistent with the defining characteristics of a system 202 of fully indexable cutting portions 206 as described above.

While an illustrative embodiment of a system 202 of fully indexable cutting portions 206 for a shear has been described in detail herein, it is to be understood that the inventive concepts may be otherwise variously embodied and employed. The appended claims are intended to be construed to include such variations except insofar as limited by the prior art. Possible variations, as described throughout this disclosure, are not to be regarded as a departure from the spirit and scope of the invention. All such possible variations, as would be obvious to one skilled in the art, are intended to be included within the scope of the preceding disclosure and the following claims.

It is understood that any variations of the features of the system and method described in the description section falls within the scope of the invention. There may be many embodiments of this invention as witnessed in some of the figures and related discussion. Not all embodiments of a system, for a shear, of fully indexable cutting portions that would fall within the scope of the claims are necessarily represented here.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The various embodiments have been described using detailed descriptions of the embodiments, as well as features, aspects, etc. thereof. The various embodiments are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described, and embodiments of the present invention comprising different combinations of features as noted in the described embodiments, will occur to persons with ordinary skill in the art.

It will be appreciated by persons with ordinary skill in the art that the present invention is not limited by what has been particularly shown and described herein above. Rather the scope of the invention is defined by the claims that follow.

What is claimed is:

1. An indexable cutting system for a shear, the system comprising:
at least one blade of a shear configured to mechanically receive a plurality of indexable cutting portions; and
a plurality of substantially identical indexable cutting portions arranged on the at least one blade to form a composite angled cutting edge, the composite angled cutting edge comprising at least one angle, each indexable cutting portion comprising:
a coupling portion for mechanically engaging the indexable cutting portion to the at least one blade; and
eight edges;
wherein each indexable cutting portion is interchangeable with each other indexable cutting portion;
wherein a first edge of each indexable cutting portion is a cutting edge that is part of the composite angled cutting edge;
wherein at least one edge of each indexable cutting portion, other than the first edge that is part of the composite angled cutting edge, is substantially parallel with at least one edge of an adjacent indexable cutting portion; and
wherein each indexable cutting portion is configured to be rotated and/or inverted such that any one of its eight edges is a cutting edge that is part of the composite angled cutting edge.

2. The system of claim 1, wherein the coupling portion is selected from a group comprising of a nut and bolt, an adhesive and a fastener.

3. The system of claim 1, wherein the ratio of the coupling portion to the indexable cutting portion is selected from a group comprising of 1:1, 4:1 and 8:1.

4. The system of claim 1, wherein the coupling portion may be one of a group comprising of one single piece, multiple discrete pieces and multiple complimentary pieces that facilitate the function of detachably coupling the system to the at least one blade.

5. The system of claim 1, wherein the plurality of substantially identical indexable cutting portions of the composite angled cutting edge are additionally configured to remain substantially aligned, oriented and rigidly coupled to the blade as the shear performs its cutting function.

6. The system of claim 1, wherein the at least one angle of the composite angled cutting edge has a range selected from a group comprising of substantially between 91.0 degrees and 179.0 degrees, substantially between 105.0 degrees and 165.0 degrees and substantially between 120.0 degrees and 150.0 degrees.

7. The system of claim 1, wherein the three dimensional shape of the plurality of substantially identical indexable cutting portions is selected from a group comprising of a parallelepiped and a cuboid.

8. The system of claim 1, wherein the indexable cutting portion has at least one pair of substantially equal sides, the shape of the at least one pair of substantially equal sides selected from a group comprising of a rhombus, a parallelogram and a quadrilateral.

9. The system of claim 1, wherein the composite angled cutting edge additionally comprises an intermediate buffer portion between at least a portion of adjacent indexable cutting portions.

10. The system of claim 1, wherein the composite angled cutting edge additionally comprises an intermediate buffer portion between at least a portion of the indexable cutting portion and the shear.

11. A system, for a shear, of fully indexable cutting portions comprising:
a coupling portion for detachably coupling the system to the blade of a shear; and
at least one composite angled cutting edge, the composite angled cutting edge comprising a plurality of adjacent individual fully indexable cutting portions defining at least one angle, the individual fully indexable cutting portion comprising:
a parallelepiped three dimensional shape;
eight edges; and
at least one pair of substantially equal parallel sides shaped as rhombi, the individual fully indexable cutting portion configured to engage with the coupling portion such that the individual fully indexable cutting portion is detachably coupled to the blade, the individual cutting portion operative to substantially:
prevent the rotational movement of an adjacent individual fully indexable cutting portion; and
be rotated and inverted such that any one of its eight edges is a cutting edge that is part of the composite angled cutting edge;
the individual cutting portion further configured to switch places with an adjacent individual fully indexable cutting portion; the at least one angle of the composite angled cutting edge defined by at least two adjacent individual fully indexable cutting portions wherein the at least two adjacent individual fully indexable cutting portions are substantially aligned and oriented as a mirror image of one another such that the at least two adjacent individual fully indexable cutting portions define the at least one angle in the composite cutting edge.

12. The system, for a shear, of fully indexable cutting portions of claim 1, wherein the coupling portion is selected from a group comprising of a nut and bolt, an adhesive and a fastener.

13. The system, for a shear, of fully indexable cutting portions of claim 1, wherein the ratio of the coupling portion to the individual fully indexable cutting portion is selected from a group comprising of 1:1, 4:1 and 8:1.

14. The system, for a shear, of fully indexable cutting portions of claim 1, wherein the coupling portion may be one of a group comprising of one single piece, multiple discrete pieces and multiple complimentary pieces that facilitate the function of detachably coupling the system to the blade of the shear.

15. The system, for a shear, of fully indexable cutting portions of claim 1, wherein the plurality of adjacent individual fully indexable cutting portions of the composite angled cutting edge are additionally configured to remain substantially aligned, oriented and rigidly coupled to the blade as the shear performs its cutting function.

16. The system, for a shear, of fully indexable cutting portions of claim 1, wherein the at least one angle of the composite angled cutting edge has a range selected from a group comprising of substantially between 91.0 degrees and 179.0 degrees, substantially between 105.0 degrees and 165.0 degrees and substantially between 120.0 degrees and 150.0 degrees.

17. The system, for a shear, of fully indexable cutting portions of claim 1, wherein the individual fully indexable cutting portion additionally comprises at least one aperture, the coupling portion configured to engage with the at least one aperture such that the individual fully indexable cutting portion is detachably coupled to the blade.

18. The system, for a shear, of fully indexable cutting portions of claim 1, wherein the composite angled cutting edge additionally comprises an intermediate buffer portion between at least a portion of adjacent individual fully indexable cutting portions.

19. The system, for a shear, of fully indexable cutting portions of claim 1, wherein the composite angled cutting edge additionally comprises an intermediate buffer portion between at least a portion of the individual fully indexable cutting portion and the shear.

20. A system, for a shear, of fully indexable cutting portions comprising:
a coupling portion for detachably coupling the system to the blade of a shear;
at least one composite angled cutting edge, the composite angled cutting edge comprising a plurality of adjacent individual fully indexable cutting portions defining at least one angle, the plurality of adjacent individual fully indexable cutting portions having substantially the same height, depth, width, volume and three dimensional shape, the individual fully indexable cutting portion comprising at least one pair of substantially equal parallel sides, the individual fully indexable cutting portion configured to engage with the coupling portion such that the individual fully indexable cutting portion is detachably coupled to the blade, the individual fully indexable cutting portion additionally comprising:
a first side of the at least one pair of substantially equal parallel sides that is distal to the blade; and
a second side of the at least one pair of substantially equal parallel sides that is proximate to the blade and lying substantially along the contours of the blade;
the individual cutting portion operative to substantially:
prevent the rotational movement of an adjacent individual fully indexable cutting portion; and
limit the rotational orientations, to a plurality of substantially discrete possibilities, by which an adjacent individual fully indexable cutting portion can detachably couple to the blade to form the composite angled cutting edge;
the individual cutting portion configured to:
switch places with an adjacent individual fully indexable cutting portion; and
invert the first side and the second side of the at least one pair of substantially equal parallel sides such that all the edges of the distal side can function as at least a portion of the angled composite cutting edge, depending on the specific rotational orientation and inversion orientation of the individual fully indexable cutting portion when detachably coupled to the blade; and
the at least one angle of the composite angled cutting edge defined by at least two adjacent individual fully indexable cutting portions.
